(19) United States
(12) Patent Application Publication
(10) Pub. No.: US 2004/0257914 A1
(43) Pub. Date: Dec. 23, 2004

(54) Portable calendar for determining the greatest likelihood of pregnancy during a woman's monthly cycle

(75) Inventor: Virginia R. Harkins, Grapevine, TX (US)

Correspondence Address: Michael L. Diaz, Michael L. Diaz, P.C., Suite 200, 555 Republic Drive, Plano, TX, 75074, US

(73) Assignee: Woods Enterprises, L.L.C.

(21) Appl. No.: 10/463,752

(22) Filed: Jun. 17, 2003

(51) Int. Cl. G04B 19/20; G04B 19/24

(52) U.S. Cl. 368/37

(57) ABSTRACT

A calendar providing an indication of the period of time in which a woman is most likely to conceive during a calendar month. The calendar includes an inner wheel rotatably attached to an outer wheel. The inner wheel includes markings indicating the relevant points of a woman's cycle to include the start of a woman's menstrual period and an at-risk phase. The outer wheel includes markings for a conventional calendar. The user aligns the start of her period with the appropriate day of the month. The user may then determine when her at-risk phase begins. During this at-risk phase, the user is most likely to conceive if engaging in sexual intercourse. The calendar is portable and may include an optional locking device for locking the aligned inner wheel against the outer wheel.

### BACKGROUND OF THE INVENTION

1. Technical Field of the Invention

This invention relates to calendars, and more particularly, to a calender for determining the greatest chance of becoming pregnant during a month.

2. Description of Related Art

The United States has one of the highest unwanted pregnancy rates among the industrialized nations. A primary reason for this high rate is the lack of education provided to women on pregnancy issues. Specifically, many women are not aware that during their monthly reproductive cycles, their greatest chance of becoming pregnant occurs before and during the time a woman ovulates. In addition, even though a woman may be aware that she is more likely to become pregnant while ovulating, most women lose track of when they are ovulating.

During the busy schedules of most women, the start date of their cycle is quickly forgotten. In addition, many women's cycles vary from a 26, 28 or 30-day cycle, which makes it difficult to correspond with the days of each month. Although the duration of these cycles is consistent for a particular woman, the length of the cycle varies from woman to woman.

The lack of proper reproductive education to women is particularly acute for women having lower incomes. Due to various social and economic reasons, women within these lower income levels are more prone to become pregnant. Since many women lack the knowledge to determine their likelihood of pregnancy, it becomes a vicious cycle of unwanted pregnancies to the poor.

An apparatus is needed, which provides a simple, inexpensive, and portable way of allowing a woman to quickly and easily determine when she is more likely to become pregnant. It would be advantageous to have such an apparatus to enable a woman to determine when extra precautions or abstinence from sex is particularly necessary. It is an object of the present invention to provide such an apparatus.

### SUMMARY OF THE INVENTION

In one aspect, the present invention is a reproductive calendar for determining a highest likelihood of becoming pregnant during a woman's monthly reproductive cycle. The calendar includes an outer wheel displaying a plurality of calendar days and an inner wheel displaying a plurality of relevant points of a reproductive monthly cycle of a woman. The inner wheel is rotatably attached to the outer wheel. The inner wheel is aligned to display at least one relevant point of the woman's reproductive monthly cycle against an appropriate calendar day displayed on the outer wheel. The woman determines an at-risk phase of the woman's monthly reproductive cycle when aligning the inner wheel with the appropriate calendar days displayed on the outer wheel. The at-risk phase indicates to the woman the highest likelihood of becoming pregnant-during the woman's monthly reproductive cycle.

In another aspect, the present invention is a reproductive calendar for determining a highest likelihood of becoming pregnant during a woman's monthly reproductive cycle. The calendar includes an inner wheel displaying a plurality of calendar days and an outer wheel displaying a plurality of relevant points of a reproductive monthly cycle of a woman. The inner wheel is rotatably attached to the outer wheel. The outer wheel is aligned to display at least one relevant point of the woman's reproductive monthly cycle against an appropriate calendar day displayed on the inner wheel. The woman determines an at-risk phase of the woman's monthly reproductive cycle when aligning the outer wheel with the appropriate calendar days displayed on the inner wheel. The at-risk phase indicates to the woman the highest likelihood of becoming pregnant during the woman's monthly reproductive cycle.

In still another aspect, the present invention is a method of determining a highest likelihood of becoming pregnant during a woman's monthly reproductive cycle utilizing a reproductive calendar. The method begins by a woman determining a duration of the monthly reproductive cycle of the woman. Next, the woman determines the first day of a menstrual cycle of the woman. The woman then aligns the reproductive calendar to indicate when the woman is at greatest risk to become pregnant. The woman then references the time when the woman is ovulating to determine the highest likelihood of becoming pregnant.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a time line indicating a woman's monthly cycle;

FIG. 2 illustrates a front view of an inner wheel;

FIG. 3 illustrates a front view of an outer wheel;

FIG. 4 is a front view of the inner wheel rotatably attached to the outer wheel in the preferred embodiment of the present invention; and

FIG. 5 is a flow chart illustrating the steps for utilizing the abstinence calendar according to the teachings of the present invention.

### DETAILED DESCRIPTION OF EMBODIMENTS

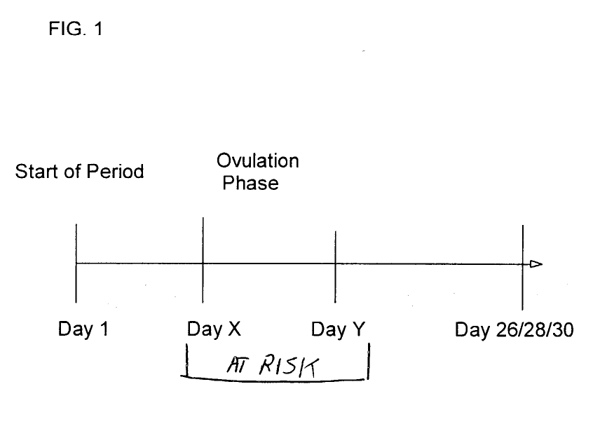

FIG. 1 is a time line 10 indicating a woman's monthly cycle. The time line illustrates a horizontal axis showing sequential events of a woman's reproductive monthly cycle. At the far left of the time line is the start of a woman's menstrual cycle. After several days (Day X), the woman ovulates for several days (end of ovulation marked by day Y). During this at-risk phase, the woman has the highest probability of conceiving. However, since sperm may live within a woman for five days. Therefore, a woman is at the greatest risk of becoming pregnant about four days prior to ovulation and through ovulation. Although there is a chance a woman may become pregnant during other times during the month, the highest chance of conceiving occurs before and during the at-risk phase. The far right portion of the time line illustrates the start of a new menstrual cycle.

The menstrual cycle of each month varies in its length. Most common is a length of time of 26, 28, or 30 days. Although a specific woman's menstrual cycle may vary in its duration and timing, typically a woman's cycle usually is one of three lengths of time of the cycle (i.e., 26, 28, or 30 days).

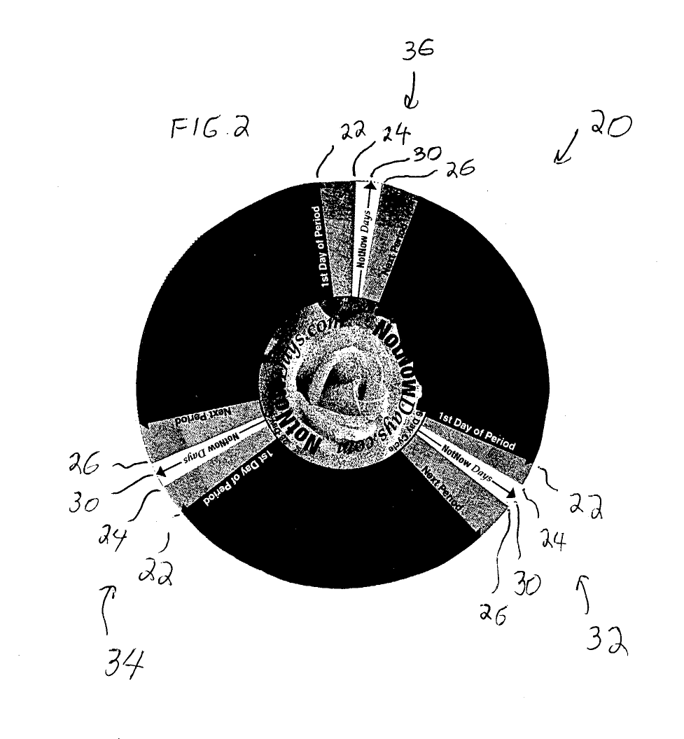

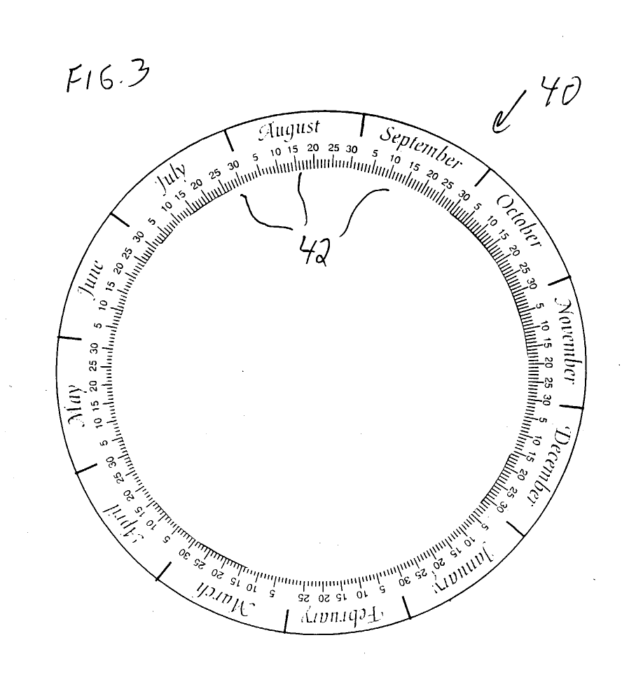

FIG. 2 illustrates a front view of an inner wheel 20. The inner wheel 20 may include markings such as an index marking 22. As illustrated, the index marking is an arrow. The index marking is used for aligning the inner wheel with an outer wheel 40 (FIG. 3). The inner wheel also includes an at-risk start indicator 24 followed by an end of ovulation indicator 26. The at-risk start indicator provides an indication four days prior to the start of a woman's ovulation phase. The second marking is an end of ovulation indicator 26 displaying the end of the ovulation phase (typically seven days after the at-risk start indicator). The days aligned between the at-risk start indicator and the end of ovulation indicator are the days in which a woman is within an at-risk phase 30. As indicated above, the at-risk phase is the period of time where a woman is most likely to conceive.

The inner wheel 20 shows three different circularly aligned cycles. The first cycle 32 illustrates a woman cycle having a duration of 26 days. The second cycle 34 illustrates a woman's cycle having a duration of 28 days. The third cycle 36 illustrates a woman's cycle having a duration of 30 days.

It should be understood that any indicator may be used to illustrate the various relevant points of a woman's cycle. Such indicators may include color coding, indices or other textual markings to indicate the various relevant points of the woman's cycle. Additionally, three cycle durations are illustrated on the inner wheel. However, the wheel may be configured for only one cycle or multiple cycles. Additionally, the at-risk phase may be at any point during a woman's cycle. Specifically, other means may be used to determine the time period during a woman's monthly cycle when the woman is at greatest risk of becoming pregnant. These relevant points of time may be illustrated on the inner wheel.

FIG. 3 illustrates a front view of an outer wheel 40. The outer wheel illustrates a plurality of markings 42 indicating the days of a month. The markings are numbered in five day increments to show the days of the month. For reference only, in the preferred embodiment of the present intention, each month is arranged about the circumference of the outer wheel.

Although the inner wheel 20 illustrates a plurality of indices indicating the various points of a woman's cycle and the outer wheel 40 illustrates conventional calendar days, the markings and indices may be configured differently from that illustrated in FIG. 3. For example, the daily markings may be located on the inner wheel and the outer wheel may display the various relevant points within a woman's cycle.

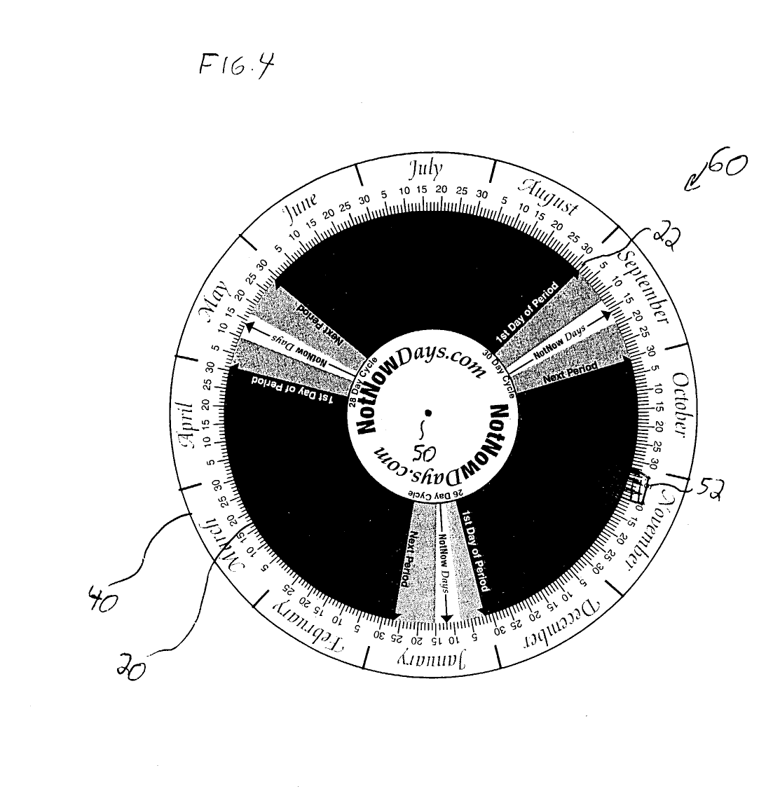

FIG. 4 is a front view of the inner wheel 20 rotatably attached to the outer wheel 40 in the preferred embodiment of the present invention. The inner wheel is preferably attached about a center point 50. The center point is preferably a grommet allowing rotational movement of the inner wheel in relationship to the outer wheel. The inner wheel may be rotated to align the index marking 22 located on the inner wheel with the appropriate day of the calendar month shown on the outer wheel. The various relevant points of a woman's reproductive cycle are spaced and configured to match a duration of time displayed as calendar days on the outer wheel. The combination of the inner wheel properly aligned with the outer wheel proves an abstinence calendar 60. The inner wheel may be optionally held in position in relation to the outer wheel by a locking device 52. The locking device may be any device preventing the inadvertent movement of the inner wheel in relation to the outer wheel. In the preferred embodiment of the present invention, the locking device is a piece of tape attached to the outer wheel and holding onto the inner wheel, thereby preventing rotation of the inner wheel in relationship to the outer wheel.

With reference to FIGS. 1-4, the operation of the abstinence calendar 60 will now be explained. First, the user determines the typical duration of her monthly cycle. Typically, the duration of a woman's cycle is either 26, 28, or 30 days. Next, the user determines when the first day of her menstrual cycle begins. This may be determined at the time of occurrence of the start of the user's period or recalled by the user. The user then aligns the index marking 22 located on the inner wheel with the appropriate day of the month located on the outer wheel. The user then selects the appropriate index marking for her determined normal cycle duration. Once aligned, the user may optionally lock the inner wheel against the outer wheel with the locking device 52. The user may then reference the calender through the month to determine when her at-risk phase 30 is occurring. This at-risk phase may be indicated between the at-risk start indicator 24 and the end of ovulation indicator 26. Referencing the at-risk phase, the user should be aware that she is most likely to conceive if engaging in sexual relations. The index marking may be realigned each month at the beginning of each user's menstrual cycle.

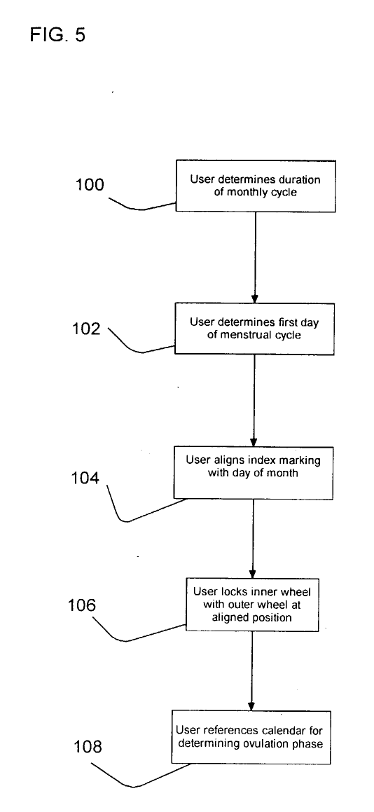

FIG. 5 is a flow chart illustrating the steps for utilizing the abstinence calendar 60 according to the teachings of the present invention. With reference to FIGS. 1-4, the operation of the abstinence calendar 60 will now be explained. The method begins with step 100 where the user determines the typical duration of her monthly cycle. Most commonly the duration is either 26, 28, or 30 days. Next, in step 102, the user determines when the first day of her menstrual cycle begins. This may be determined at the time of occurrence of the start of her period or recalled by the user. The method then moves to step 104, where the user aligns the index marking 22 located on the inner wheel with the appropriate day of the month located on the outer wheel. The user must use the proper index marking for the appropriate duration of the user's cycle determined in step 100. Next, in step 106, the user may optionally lock the inner wheel against the outer wheel with the locking device 52. Preferably, the locking device is a piece of tape locking the inner wheel to the outer wheel. In step 108, the user then references the abstinence calender throughout the month to determine when her at-risk phase 30 is occurring. This at-risk phase may be indicated from the beginning of the phase by the at-risk start indicator 24 and the end of the phase by the end of ovulation indicator 26. Referencing the at-risk phase, the user is provided with an indication of when she is most likely to conceive if engaging in sexual intercourse. The index marking may be realigned each month at the beginning of ear user's menstrual cycle as necessary to adjust for variances in the start of the user's cycle.

The abstinence calendar provides many advantages. First, it provides an indication to the user of when she is most likely to conceive. With this knowledge, the user may take appropriate actions, such as abstaining from sexual intercourse or utilizing birth control devices. The abstinence calendar is simple to use by almost any woman. The calendar is also portable, allowing easy access by the user at anytime. In addition, it provides a time line corresponding with the month. This time line provides a useful reminder to the user of when a menstrual cycle is to begin and end. Overall, the abstinence calendar provides a memorialization of the relevant dates of woman's monthly reproductive cycle.

It is thus believed that the operation and construction of the present invention will be apparent from the foregoing description. While the apparatus and method shown and described has been characterized as being preferred, it will be readily apparent that various changes and modifications could be made therein without departing from the scope of the invention as defined in the following claims.

What is claimed is:

1. A reproductive calendar for determining a highest likelihood of becoming pregnant during a woman's monthly reproductive cycle, said calendar comprising:
an outer wheel displaying a plurality of calendar days; and
an inner wheel displaying a plurality of relevant points of a reproductive monthly cycle of a woman;
said inner wheel being rotatably attached to said outer wheel, said inner wheel being aligned to display at least one relevant point of the woman's reproductive monthly cycle against an appropriate calendar day displayed on said outer wheel;
whereby the woman determines an at-risk phase of the woman's monthly reproductive cycle when aligning said inner wheel with the appropriate calendar days displayed on said outer wheel, the at-risk phase indicating to the woman the highest likelihood of becoming pregnant during the woman's monthly reproductive cycle.

2. The reproductive calendar of claim 1 wherein said outer wheel displays the months of a year.

3. The reproductive calendar of claim 1 wherein said outer wheel displays the days of a month.

4. The reproductive calendar of claim 1 wherein said inner wheel displays a starting day of a woman's menstrual cycle.

5. The reproductive calendar of claim 4 wherein the starting day of a woman's menstrual cycle displayed on said inner wheel is aligned with the calendar day on which the woman's menstrual cycle begins displayed on said outer wheel.

6. The reproductive calendar of claim 5 wherein said inner wheel displays a beginning and end of the at-risk phase.

7. The reproductive calendar of claim 1 wherein said inner wheel displays a beginning and end of the at-risk phase.

8. The reproductive calendar of claim 1 further comprising a locking device for locking said inner wheel against said outer wheel when said inner wheel is appropriately aligned with said outer wheel.

9. The reproductive calendar of claim 9 wherein said inner wheel displays a plurality of cycle durations, each cycle duration illustrating at least one relevant point of a woman's reproductive monthly cycle.

10. A reproductive calendar for determining a highest likelihood of becoming pregnant during a woman's monthly reproductive cycle, said calendar comprising:
an inner wheel displaying a plurality of calendar days; and
an outer wheel displaying a plurality of relevant points of a reproductive monthly cycle of a woman;
said inner wheel being rotatably attached to said outer wheel, said outer wheel being aligned to display at least one relevant point of the woman's reproductive monthly cycle against an appropriate calendar day displayed on said inner wheel;
whereby the woman determines an at-risk phase of the woman's monthly reproductive cycle when aligning said outer wheel with the appropriate calendar days displayed on said inner wheel, the at-risk phase indicating to the woman the highest likelihood of becoming pregnant during the woman's monthly reproductive cycle.

11. The reproductive calendar of claim 10 wherein said inner wheel displays the months of a year.

12. The reproductive calendar of claim 10 wherein said inner wheel displays the days of a month.

13. The reproductive calendar of claim 10 wherein said outer wheel displays a starting day of a woman's menstrual cycle.

14. The reproductive calendar of claim 13 wherein the starting day of a woman's menstrual cycle displayed on said outer wheel is aligned with the calendar day on which the woman's menstrual cycle begins displayed on said inner wheel.

15. The reproductive calendar of claim 14 wherein said outer wheel displays a beginning and end of the at-risk phase.

16. The reproductive calendar of claim 10 wherein said outer wheel displays a beginning and end of the at-risk phase.

17. The reproductive calendar of claim 10 further comprising a locking device for locking said inner wheel against said outer wheel when said inner wheel is appropriately aligned with said outer wheel.

18. The reproductive calendar of claim 10 wherein said outer wheel displays a plurality of cycle durations, each cycle duration illustrating at least one relevant point of a woman's reproductive monthly cycle.

19. A method of determining a highest likelihood of becoming pregnant during a woman's monthly reproductive cycle utilizing a reproductive calendar, said method comprising the steps of:
determining, by the woman, a duration of the monthly reproductive cycle of the woman;
determining, by the woman, the first day of a menstrual cycle of the woman;
aligning, by the woman, the reproductive calendar to indicate when the woman is at greatest risk to become pregnant; and
referencing the time when the woman is ovulating, by the woman, to determine the highest likelihood of becoming pregnant.

20. The method of determining a highest likelihood of becoming pregnant during a woman's monthly reproductive cycle of claim 19 wherein the reproductive calendar includes an inner wheel displaying at least one relevant point of a woman's reproductive cycle and an outer wheel displaying days of a month.
